(19) United States
(12) Patent Application Publication
(10) Pub. No.: US 2008/0147911 A1
(43) Pub. Date: Jun. 19, 2008

(54) Pen Drive Having Integral File Transfer Capability and Method of Operation Thereof

(76) Inventor: David H. Hitt, Plano, TX (US)

Correspondence Address: HITT GAINES P.C., P.O. BOX 832570, RICHARDSON, TX, 75083, US

(21) Appl. No.: 11/553,805

(22) Filed: Oct. 27, 2006

(51) Int. Cl. G06F 13/00

(52) U.S. Cl. 710/33

(57) ABSTRACT

A pen drive and a method of operating the same. In one embodiment, the pen drive has a body and includes: (1) a nonvolatile main memory, (2) a Universal Serial Bus (USB) port coupled to the nonvolatile main memory and including a USB plug, (3) a power source, (4) a USB host controller coupled to the nonvolatile main memory and powered by the power source, (5) a USB receptacle coupled to the USB host controller and (6) a processor coupled to the USB host controller and the nonvolatile main memory and configured to initiate a transfer of at least one user file therebetween.

### TECHNICAL FIELD OF THE INVENTION

The invention is directed, in general, to computer memory peripheral devices arid, more particularly, to a pen drive having integral file transfer capability and method of operation thereof.

### BACKGROUND OF THE INVENTION

“Pen drives” have become a widely used device for carrying one's computer files about. As is widely known, a pen drive, also called a “memory stick” or a “jump drive,” is a solid-state device containing nonvolatile computer memory, typically flash random-access memory (RAM), and a Universal Serial Bus (USB) port that allows external access to the nonvolatile memory.

To use the pen drive, a user connects the pen drive to a corresponding USB receptacle on a host device, typically a computer. In accordance with the USB standard (which is controlled by the USB Implementers Forum, Inc. (usb.org), the host device automatically detects that a USB device has been connected to it, determines what kind of USB device it is by means of the USB controller and, if the USB device is a pen drive (which it is in this case), treats the pen drive as a logical volume of storage, like a hard disk drive. In this manner, the user can read files from, and write files to, the pen drive.

The beauty of the pen drive is that it can be connected to a host device without having to install a driver for it or reboot the host device, disconnected from the host device without having to reboot the host device and thereafter carry it around, perhaps in one's pocket or briefcase or perhaps suspended from a lanyard about one's neck. Being solid state and packaged in a relatively small, light and durable case, pen drives are reliable, tough and very easy to carry about. For this reason, pen drives have largely displaced floppy disks and even compact disks as portable storage media.

Because the market is so large, quite a number of companies produce pen drives. As a result, pen drives are virtual commodities, with storage capacities increasing and prices decreasing almost daily. This indicates that the popularity of pen drives will continue to increase.

As portable, capacious, durable and easy to use as pen drives now are, they can still benefit from further improvement. What is needed in the art is a way to make pen drives even more flexible and powerful. Most advantageously, pen drives should be made more flexible and powerful without diminishing their portability, capacity, durability and ease of use.

### SUMMARY OF THE INVENTION

To address the above-discussed deficiencies of the prior art, the invention provides, in one aspect, a pen drive. In one embodiment, the pen drive has a body and includes: (1) a nonvolatile main memory, (2) a USB port coupled to the nonvolatile main memory and including a USB plug, (3) a power source, (4) a USB host controller coupled to the nonvolatile main memory and powered by the power source, (5) a USB receptacle coupled to the USB host controller and (6) a processor coupled to the USB host controller and the nonvolatile main memory and configured to initiate a transfer of at least one user file therebetween.

In another aspect, the invention provides a method of operating a pen drive having a nonvolatile main memory, a USB port including a USB plug, a power source, a USB host controller, a USB receptacle coupled to the USB host controller and a processor. In one embodiment, the method includes: (1) employing the power source to provide power to the USB host controller and (2) initiating with the processor a transfer of at least one user file between the USB host controller and the nonvolatile main memory.

In yet another aspect, the invention provides a pen drive that includes: (1) an elongated body having opposing first and second ends, (2) a nonvolatile main memory located in the body, (3) a USB mass storage controller located in the body and coupled to the nonvolatile main memory, (4) a USB plug projecting from the first end and coupled to the USB mass storage controller, (5) a battery located in the body, (6) a USB host controller located in the body, coupled to the nonvolatile main memory and powered by the battery, (7) a USB receptacle recessed into the second end and coupled to the USB host controller and (8) a processor located in the body, coupled to the USB host controller and the nonvolatile main memory and configured to initiate a transfer of at least one user file therebetween.

The foregoing has outlined preferred and alternative features of the invention so that those skilled in the pertinent art may better understand the detailed description of the invention that follows. Additional features of the invention will be described hereinafter that form the subject of the claims of the invention. Those skilled in the pertinent art should appreciate that they can readily use the disclosed conception and specific embodiment as a basis for designing or modifying other structures for carrying out the same purposes of the invention. Those skilled in the pertinent art should also realize that such equivalent constructions do not depart from the scope of the invention.

### BRIEF DESCRIPTION OF THE DRAWINGS

For a more complete understanding of the invention, reference is now made to the following descriptions taken in conjunction with the accompanying drawing, in which:

FIG. 1 illustrates a high-level block diagram of one embodiment of a pen drive constructed according to the principles of the invention;

FIGS. 2A, 2B and 2C together illustrate the pen drive of FIG. 1 employed in three possible modes of operation: a host mode (FIG. 2A), a hosted mode (FIG. 2B) and a pass-through mode (FIG. 2C);

FIG. 3 illustrates a screen shot of a configuration program that may be employed to configure a user-configurable embodiment of the pen drive of FIG. 1; and

FIG. 4 illustrates a flow diagram of one embodiment of a method of operating a pen drive carried out according to the principles of the invention

### DETAILED DESCRIPTION

Before describing technical aspects of various embodiments of a novel pen drive in detail, its use and possible advantages should be understood in nontechnical, colloquial terms. With a pen drive as described herein, a user can, for example, transfer user files automatically to or from another pen drive (of any type, including conventional pen drives) without having to do anything more than plug the two pen drives together. No computer is required to effect the transfer. No buttons need to be pushed; no computer screens need to be read; nothing needs to be plugged into a wall outlet; no email or text messages need to be sent.

This peer-to-peer file transfer capability is highly advantageous in several real-world contexts. In a work environment, a user can transfer the file(s) containing his business presentation directly to those in the audience who want an electronic copy of it. Business-related files can be directly swapped at trade shows, airports, seminar ballrooms, golf courses without having to rely on computers or other devices. In an educational environment, a teacher may pass an assignment out by transferring it directly to the students' pen drives, and students may in turn transfer their homework or projects from their pen drives directly to the teacher's. At a party, people may trade files (such as pictures or homemade audio recordings or videos) with each other as a natural part of their mingling. Those skilled in the pertinent art will understand how advantageous it is to have a pen drive that automatically transfers files without the need for further hardware or software and without compromising the portability, light weight, durability and flexibility pen drives currently afford. Those skilled in the pertinent art will also see many applications for the pen drive of the invention that may not be described herein. All such applications fall within the scope of the invention.

Having described in layman's terms some of possible uses and advantages of the invention, some embodiments will now be described. FIG. 1 illustrates a high-level block diagram of one embodiment of a pen drive, generally designated 100 and constructed according to the principles of the invention. The pen drive 100 contains some components that are found in conventional pen drives. The pen drive 100 has a tough, rigid, elongated body 105, typically formed of plastic, that serves to support the various components contained within it. The body 100 has a first end 110 and a second end 115 opposite the first end, as shown. A USB plug 120 extends from the first end. The USB plug may be a Type A USB plug, but can be of any other type.

A nonvolatile main memory 125, which in the illustrated embodiment is a flash memory, is contained within the body 105. The nonvolatile main memory 125 is configured to provide storage for user files, which may take the form of files, folders (also called “subdirectories”) or other data of interest to a user. (The nonvolatile main memory 125 may also provide storage for non-user files, such as system files and directory and formatting data.) The nonvolatile main memory 125 is advantageously of large capacity, typically greater than 100 megabytes (MB), but may be one gigabyte (GB) or larger.

A USB mass storage controller 130 is coupled to the nonvolatile main memory 125 and the USB plug 120. Together, the USB mass storage controller 130 and the USB plug 120 are regarded as a USB port. As those skilled in the pertinent art understand, the USB mass storage controller 130 is configured to communicate through the USB plug 120 to establish a logical connection with a hosting device (not shown in FIG. 1), such as a computer. During the establishment of that logical connection, the USB mass storage controller 130 communicates information regarding the pen drive 100 such that the hosting device may understand its storage and file transfer capabilities.

The pen drive 100 of FIG. 1 also contains two components that are found on some conventional pen drives, but not on all. An indicator lamp 135 is coupled to the body 105 such that it can be viewed from outside of the body 105. In the illustrated embodiment, the indicator lamp 135 is a light-emitting diode (LED). However, this need not be the case.

A write-enable switch 140 is coupled to the body 105 such that it can be moved from outside of the body 105. In one position, the write-enable switch 140 allows user files to be written to the nonvolatile main memory 125. In another position, the write-enable switch 140 disallows such writing, protecting the contents of the nonvolatile main memory 125 from accidental erasure. In the illustrated embodiment, the write-enable switch 140 is a slide switch. However, this need not be the case.

The pen drive 100 of FIG. 1 also contains components that are novel to the invention and therefore not found in conventional pen drives. A processor 145 is coupled to the nonvolatile main memory 125 and is configured to function in a variety of ways that will be described below. The processor 145 may be a microprocessor, microcontroller, digital signal processor (DSP) or any other kind of processor having sufficient capability to provide the functions desired of the processor 145. Further, the processor 145 may be separate from other components of the pen drive 100 or integral with one or more of those components. For example, the processor 145 may be integral with a USB controller (e.g., the USB mass storage controller 130), if that controller has sufficient capability to provide the functions desired of the processor 145.

A USB receptacle 150 recesses into the second end 115 of the body 105. The USB receptacle may be a Type A USB receptacle. The USB receptacle 150 may be of the same USB Type (Type A, Type B, etc.) as the USB plug 120. Further, the USB receptacle 150 need not be located proximate the second end 115. Instead, the USB receptacle 150 (and, for that matter, the USB plug 120) may recess into or project from any part of the body 105.

A USB host controller 155 is coupled to the USB receptacle 150 and the nonvolatile main memory 125. Together, the USB host controller 155 and the USB receptacle 150 may be regarded as a USB port. As those skilled in the pertinent art understand, the USB host controller is configured to communicate through the USB plug 120 to establish a logical connection with a hosted device (not shown in FIG. 1), such as another pen drive. During the establishment of that logical connection, the USB host controller 155 provides power to the hosted device, requests information regarding the hosted device such that the pen drive 100 may understand its storage and/or data transfer capabilities and communicates with the hosted device in accordance with that information.

As previously stated, the USB host controller 155 provides power to the hosted device. Accordingly, the pen drive 100 includes a power source 160, advantageously located within the body 105. In the embodiment of FIG. 1, the power source 160 includes, and in fact may be, a battery, perhaps of the lithium-ion type, and perhaps accessible via a door (not shown) in the body 150 such that it can be replaced as needed.

Two components that may assist the processor 145 in providing its desired functions will now be described. A program memory 165 is coupled to the processor 145 and contains a control program that controls operation of the processor 145, to cause, for example, the transfer of at least one file to or from the pen drive 100. Certain functions that the processor 145 may perform will be described herein, with the understanding that many possible functions are possible without departing from the invention.

The program memory 165 may be quite small in terms of its storage capacity (perhaps on the order of kilobytes, or KB). In the embodiment of FIG. 1, the program memory 165 is read-only memory (ROM). In one embodiment, the program memory 165 is externally addressable and contains a configuration program in addition to the control program that controls operation of the processor 145. An exemplary configuration program will be described below, with the understanding that many possible configurations are possible without departing from the invention.

A configuration memory 170 is likewise coupled to the processor 145. The configuration memory 170 contains configuration data that, in conjunction with the control program, controls the operation of the processor 145. The configuration memory of FIG. 1 is extremely small, on the order of a single 16-bit register, since the functions that the processor 145 is to perform in the illustrated embodiments are limited and of limited variation. The configuration data may be factory-preset or user-configurable via, e.g., the configuration program.

The program memory 165 and configuration memory 170 may be embedded with the processor 145 on a single integrated circuit (IC) chip or may be separate ICs. In fact, many of the components of the pen drive 100 may be integrated into a single, application-specific IC (ASIC) for compactness and ease of assembly.

Though the embodiment of FIG. 1 is relatively simple, more complex embodiments fall within the scope of the invention. For example, the pen drive 100 may be provided with one or more user-operable buttons to allow, for example, the user manually to initiate or terminate a file transfer or to control the direction of the file transfer. The pen drive 100 may be provided with a display, perhaps a rudimentary liquid crystal display (LCD), allowing more status data to be displayed and perhaps allowing user decisions to be based thereon. With a display, the indicator lamp 135 would probably no longer be necessary. The pen drive 100 may be provided with a vibrator or a speaker, which would provide other means of informing a user about a file transfer.

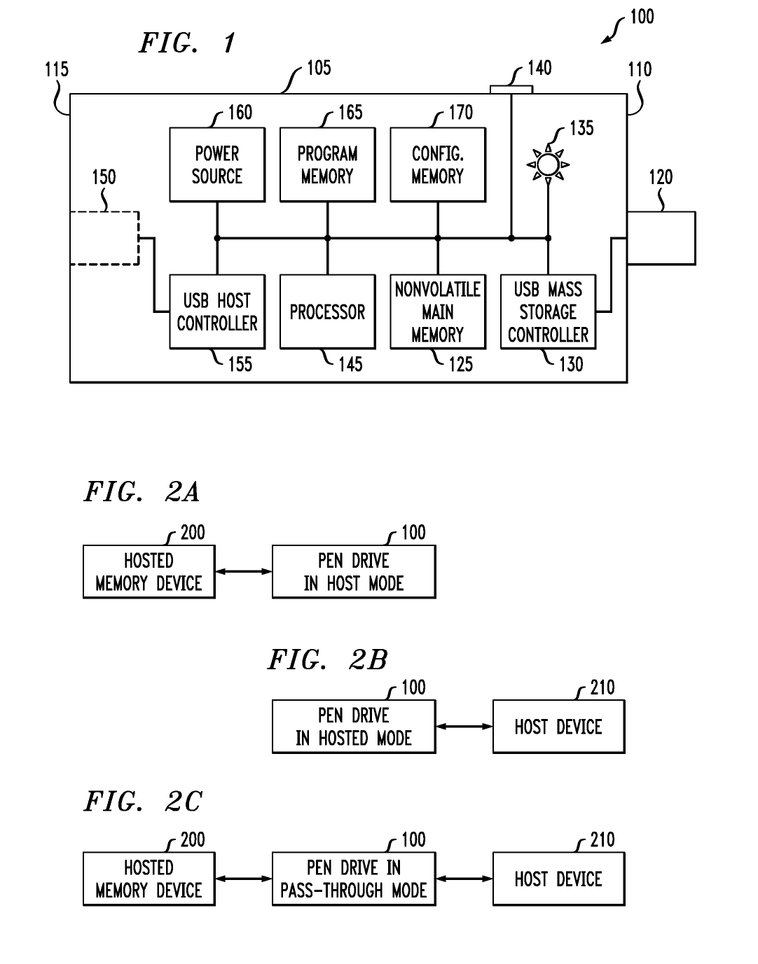

Having described some embodiments of the pen drive 100, various possible modes of operation will now be described. FIGS. 2A, 2B and 2C together illustrate the pen drive of FIG. 1 employed in three possible modes of operation: a host mode (FIG. 2A), a hosted mode (FIG. 2B) and a pass-through mode (FIG. 2C).

In the host mode of FIG. 2A, a hosted memory device 200 is coupled to the USB receptacle 150 (see FIG. 1) of the pen drive 100. In response, the USB host controller (see FIG. 1) automatically provides power to the hosted device (in this case a hosted memory device 200) and requests and receives information regarding the hosted memory device 200 such that the pen drive 100 may understand its storage and data transfer capabilities. Thereafter, and preferably automatically, the processor (see FIG. 1) initiates a transfer of at least one user file (files, folders or other data of interest to a user) between the hosted memory device 200 and the pen drive 100.

The transfer may he a transfer from the hosted memory device 200 to the pen drive 100, a transfer from the pen drive 100 to the hosted memory device 100, or both. During the transfer, the indicator lamp (see FIG. 1) on the pen drive 100 may blink to prompt the user to keep the hosted memory device 200 and the pen drive 100 coupled together until the transfer is complete. Following the transfer, the indicator lamp may turn off or remain constantly on. In an embodiment to be described, a user can configure the operation of the indicator lamp.

In the hosted mode of FIG. 2B, the pen drive 100 operates primarily as a conventional pen drive. When the pen drive 100 is coupled to a USB receptacle (not shown) on a host device 210, the USB host controller (not shown) of the host device 210 automatically provides power to the pen drive 100 and requests and receives information regarding the pen drive 100 such that the host device 210 may understand its storage and data transfer capabilities. Thereafter, the pen drive 100 appears as a logical volume of storage, like a disk drive, to the host device 210. User files (e.g., files, folders or other data of interest to a user) can be transferred to or from the pen drive 100 by interacting with a file transfer application program (e.g., Microsoft® Windows® Explorer) executing on the host device 210.

In the pass-through mode of FIG. 2C, not only is the pen drive 100 coupled to the host device 210 as in FIG. 2B, but the hosted memory device 200 is also coupled to the pen drive 100 as in FIG. 2A. In the illustrated embodiment, the pen drive 100 serves as a logical volume of storage for the host device 210 and further allows the hosted memory device 200 to serve as another logical volume of storage for the host device 210. The pass-through mode, at least with respect to the illustrated embodiment, is therefore a USB port-saving feature; a single USB port on the host device 210 can support two USB devices.

In the illustrated embodiment, user files are not automatically transferred between the hosted memory device 200 and the nonvolatile main memory (see FIG. 1) of the pen drive 100; the user may perform that task if desired using the host device 210. Further, it is assumed that the host device 210 provides power for both the pen drive 100 and the hosted memory device 200; the power source (see FIG. 1) of the pen drive 100 is therefore spared the task. Finally, in an embodiment to be described, a user can selectively activate the pass-through mode.

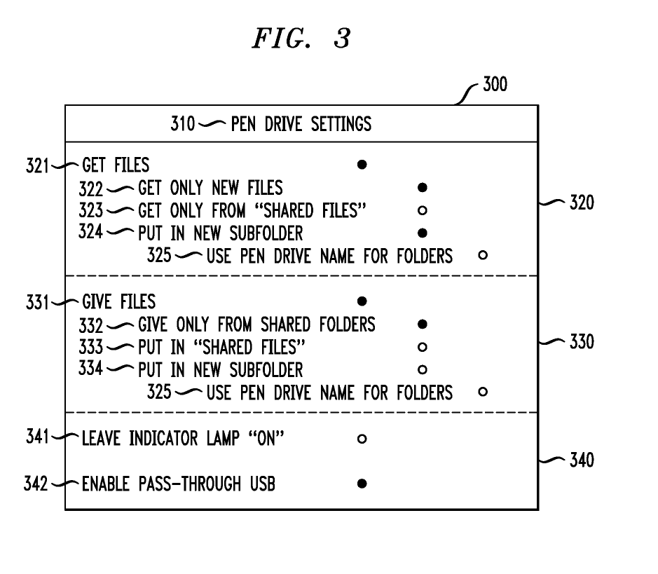

In several embodiments, the pen drive further includes a configuration program executable on a host device (e.g., the host device 210) to allow a user to configure the configuration data contained in the configuration memory (see FIG. 1) of the pen drive 100. FIG. 3 illustrates a screen shot 300 of a rudimentary configuration program that may be employed to configure a user-configurable embodiment of the pen drive of FIG. 1.

Before describing the screen shot 300, it should be noted that the configuration program could be provided on a disk sold with the pen drive 100 or, more advantageously, stored in the pen drive, e.g., in the program memory 165 of FIG. 1. In the latter case, the configuration program might appear as an executable (e.g., .com or .exe) file in the pen drive when the pen drive is coupled to the host device. The configuration program can then be executed off the pen drive without the need for a separate disk.

Turning now to the screen shot 300, under a title 310, is a list of possible configuration settings (not separately referenced). The user can select or deselect configuration settings by blackening or whitening bullets (also not separately referenced) located next to each of the configuration settings as shown. Those skilled in the art know that the spacebar or a mouse click can be used for blackening and whitening bullets.

The configuration settings illustrated in FIG. 3 will be described with the understanding that they are merely examples of possible pen drive functions. More or fewer configuration settings may be desired, depending upon how sophisticated or simple the pen drive functions are to be for a given embodiment. The configuration settings are grouped into three groups: a GET FILES group 320, a GIVE FILES group 330 and a miscellaneous group 340. The GET FILES and GIVE FILES groups 320, 330 and the upper configuration setting of the miscellaneous group 340 pertain to the host mode. The lower configuration setting of the miscellaneous group 340 pertains to the pass-through mode.

In the GET FILES group 320, a user can first select (via a configuration setting 321) whether or not the pen drive should get any files from the hosted memory device when the pen drive is in host mode. If the user does not want the pen drive to get any files, the bullet next to the configuration setting 321 should be whitened; otherwise it should be blackened. Assuming, as shown, that the user wants the pen drive to get files, he now can configure what files and how they should be stored on the pen drive. Accordingly, the user can select (via a configuration setting 322) whether the pen drive should get only files that do not already exist on the pen drive (“new files”) or all files irrespective of their pre-existence on the pen drive. Then the user can select (via a configuration setting 323) whether the pen drive should get files only from a folder on the hosted memory device named “Shared Files.” This allows users to define a “Shared Files” folder on their pen drives from which files are shared. If the configuration setting 323 is whitened, all files are transferred from the hosted memory device, irrespective of the folder in which they may be contained.

Then the user can decide how to store the received files on the pen drive. The user can select (via a configuration setting 324) whether a new subfolder should be created for the files or whether the files should be stored in the pen drive's root folder. The former allows files to be grouped by origin, making it easier to determine from whom a file was received. The latter results in a simpler folder structure. If the former is selected, the user can then select (via a configuration setting 325) how to name the newly-created folders. Being a USB device, the hosted memory device (called “pen drive” in the configuration setting 325) has a logical name that it provides to the hosting pen drive. That name can be used as the folder name, or the pen drive can assign a unique name to the folder based upon some convention, perhaps an incrementing number. As is apparent from FIG. 3, the user wants the pen drive to get only new files and put them in a folder that the pen drive assigns a unique name based upon some convention.

In the GIVE FILES group 330, a user can first select (via a configuration setting 331) whether or not the pen drive should give any files to the hosted memory device when the pen drive is in host mode. If the user does not want the pen drive to get any files, the bullet next to the configuration setting 331 should be whitened; otherwise it should be blackened. Assuming, as shown, that the user wants the pen drive to give files, he now can configure what files and how they should be stored on the hosted memory device. Accordingly, the user can select (via a configuration setting 332) whether the pen drive should give only files from folders that have a “shared” permission, such as one named “Shared Files.” Those skilled in the pertinent art are aware that modern operating systems, such as Microsoft® Windows® XP®, allow folders to be shared by setting a “shared” permission to those folders.

Then the user can decide how to store the received files on the hosted memory device. The user can select (via a configuration setting 333) whether the pen drive should put the files in a folder on the hosted memory device named “Shared Files,” creating such a folder if it does not already exist. If the configuration setting 333 is whitened, files are put in the root folder of the hosted memory device. Alternatively, the user can select (via a configuration setting 334) whether a new subfolder should be created for the files. If the latter is selected, the user can then select (via a configuration setting 335) how to name the newly-created folders. The pen drive's logical name can be used as the folder name, or the pen drive can assign a unique name to the folder based upon some convention. As is apparent from FIG. 3, the user wants the pen drive to give files only from shared folders and put them in the root folder of the hosted memory device.

In the miscellaneous group 340, the user can select (via a configuration setting 341) whether, following completion of a user file transfer, the indicator lamp should be left on or turned off. The former provides a more positive indication of a successful transfer; the latter saves battery power. The user can select (via a configuration setting 342) whether or not the pen drive should operate in the pass-through mode. As is apparent from FIG. 3, the user wants the pen drive to turn the indicator lamp off following a transfer and wants to enable the pass-through mode.

Upon exiting the configuration program, the configuration program saves the configuration settings to the configuration memory (see FIG. 1), overwriting previous, perhaps factory, configuration settings.

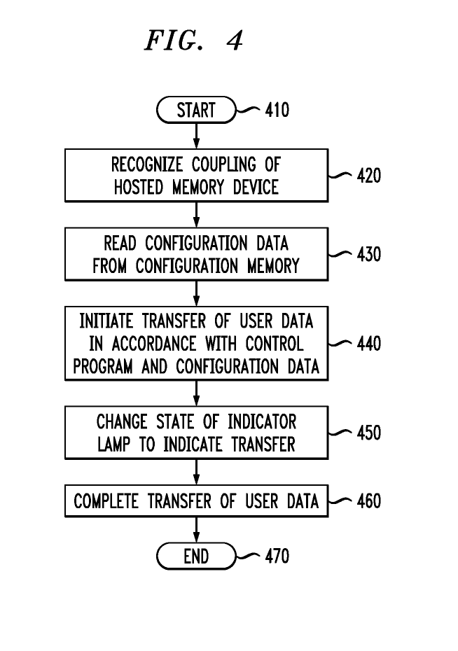

Turning now to FIG. 4, illustrated is a flow diagram of one embodiment of a method of operating a pen drive carried out according to the principles of the invention. The method begins in a start step 410.

In a step 420, the power source is employed to provide power to the USB host controller, at which time the coupling of the hosted memory device is automatically recognized in accordance with USB standards. In a step 430, the control program is automatically invoked to cause the processor to read the configuration data from the configuration memory. In a step 440, the control program causes the processor to initiate a transfer of at least one user file between the hosted memory device (via the USB host controller) and the nonvolatile main memory of the pen drive in accordance with the configuration data.

In a step 450, the control program causes the processor to change the state of the indicator lamp (perhaps from off to blinking) to indicate that a transfer has begun. In a step 460, the transfer of at least one user file is completed, and the control program again causes the processor to change the state of the indicator lamp (perhaps from blinking to off). The method ends in an end step 470.

Although the invention has been described in detail, those skilled in the pertinent art should understand that they can make various changes, substitutions and alterations herein without departing from the scope of the invention in its broadest form.

What is claimed is:

1. A pen drive having a body and comprising:
a nonvolatile main memory;
a Universal Serial Bus (USB) port coupled to said nonvolatile main memory and including a USB plug;
a power source;
a USB host controller coupled to said nonvolatile main memory and powered by said power source;
a USB receptacle coupled to said USB host controller; and
a processor coupled to said USB host controller and said nonvolatile main memory and configured to initiate a transfer of at least one user file therebetween.

2. The pen drive as recited in claim 1 wherein said nonvolatile main memory is a flash memory of at least 100 megabytes.

3. The pen drive as recited in claim 1 wherein said body is elongated and said USB plug projects from a first end of said elongated body.

4. The pen drive as recited in claim 3 wherein said USB receptacle recesses into a second end of said body opposite said first end.

5. The pen drive as recited in claim 1 wherein said USB plug and said USB receptacle are of the same USB Type.

6. The pen drive as recited in claim 1 wherein said USB plug is a Type A USB plug.

7. The pen drive as recited in claim 1 wherein said power source comprises a battery contained within said body.

8. The pen drive as recited in claim 1 further comprising an indicator lamp coupled to said body and said processor.

9. The pen drive as recited in claim 1 further comprising a program memory coupled to said processor, said transfer of said at least one user file occurring in accordance with a control program stored in said program memory.

10. The pen drive as recited in claim 1 wherein said program memory is read-only memory.

11. The pen drive as recited in claim 1 further comprising a configuration memory coupled to said processor, said transfer of said at least one user file being based on configuration data stored in said configuration memory.

12. The pen drive as recited in claim 10 wherein said configuration data is user-configurable.

13. The pen drive as recited in claim 12 further comprising a configuration program executable on a host device configured to host said pen drive to allow a user to configure said configuration data.

14. A method of operating a pen drive having a nonvolatile main memory, a Universal Serial Bus (USB) port including a USB plug, a power source, a USB host controller, a USB receptacle coupled to the USB host controller and a processor, said method comprising:
employing said power source to provide power to said USB host controller; and
initiating with said processor a transfer of at least one user file between said USB host controller and said nonvolatile main memory.

15. The method as recited in claim 14 further comprising:
detecting with said USB host controller an insertion of a hosted memory device into said USB receptacle; and
automatically carrying out said initiating in response to said detecting.

16. The method as recited in claim 14 wherein said transfer of at least one user file is from said USB host controller to said nonvolatile main memory.

17. The method as recited in claim 14 wherein said transfer of at least one user file is from said nonvolatile main memory to said USB host controller.

18. The method as recited in claim 14 wherein said pen drive further comprises a program memory and said method further comprises carrying out said transfer of said at least one user file in accordance with a control program stored in a program memory.

19. The method as recited in claim 14 wherein said pen drive further comprises a program memory and said method further comprises carrying out said transfer of said at least one user file based on configuration data stored in said configuration memory.

20. The method as recited in claim 14 further comprising activating an indicator lamp based on said initiating.

21. The method as recited in claim 14 further comprising initiating with said processor a transfer of at least one user file between said USB host controller and said USB plug when said pen drive is coupled between a host device and a hosted device.

22. A pen drive, comprising:
an elongated body having opposing first and second ends;
a nonvolatile main memory located in said body;
a Universal Serial Bus (USB) mass storage controller located in said body and coupled to said nonvolatile main memory;
a USB plug projecting from said first end and coupled to said USB mass storage controller;
a battery located in said body;
a USB host controller located in said body, coupled to said nonvolatile main memory and powered by said battery;
a USB receptacle recessed into said second end and coupled to said USB host controller; and
a processor located in said body, coupled to said USB host controller and said nonvolatile main memory and configured to initiate a transfer of at least one user file therebetween.

23. The pen drive as recited in claim 22 wherein said nonvolatile main memory is a flash memory of at least 100 megabytes.

24. The pen drive as recited in claim 22 wherein said USB plug and said USB receptacle are of the same USB Type.

25. The pen drive as recited in claim 22 wherein said USB plug is a Type A USB plug.

26. The pen drive as recited in claim 22 further comprising an indicator lamp coupled to said body and said processor.

27. The pen drive as recited in claim 22 further comprising a program memory coupled to said processor, said transfer of said at least one user file occurring in accordance with a control program stored in said program memory.

28. The pen drive as recited in claim 22 wherein said program memory is read-only memory.

29. The pen drive as recited in claim 22 further comprising a configuration memory coupled to said processor, said transfer of said at leas one user file being based on a configuration data stored in said configuration memory.

30. The pen drive as recited in claim 29 wherein said configuration data is user-configurable.

31. The pen drive as recited in claim 30 further comprising a configuration program executable on a host device configured to host said pen drive to allow a user to configure said configuration data.
